(19) United States
(12) Patent Application Publication
(10) Pub. No.: US 2021/0084055 A1
(43) Pub. Date: Mar. 18, 2021

(54) RESTRICTED WEB BROWSER MODE FOR SUSPICIOUS WEBSITES

(71) Applicant: Avast Software s.r.o., Prague 4 (CZ)

(72) Inventor: Doron Avraham, Prague 3-Zizkov (CZ)

(21) Appl. No.: 16/569,390

(22) Filed: Sep. 12, 2019

(51) Int. Cl. H04L 29/06; G06N 5/00

(52) U.S. Cl. CPC H04L 63/1416; H04L 63/145; H04L 63/083; G06N 5/003

(57) ABSTRACT

A method of restricting presentation of known or suspected malicious content in a web browser comprises receiving a request for web content, and determining whether the web content contains known or suspected malicious content. If the requested web content contains known or suspected malicious web content, the requested web content is displayed in a restricted browsing mode that restricts or blocks presentation of one or more elements of the known or suspected malicious content in the requested content.

### FIELD

The invention relates generally to web browsers such as are commonly used to browse the Internet, and more specifically to a restricted web browser mode for suspicious websites.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users to attempt to communicate with other users' computers in a manner that poses a danger. For example, a hacker may attempt to log in to a corporate computer to steal, delete, or change information. Computer viruses or Trojan horse programs may be distributed to other computers or unknowingly downloaded such as through email, download links, or smartphone apps. Ransomware may encrypt a user's files and keep them encrypted and unusable until a ransom is paid, and cryptocurrency miners may use another's computing resources to mine cryptocurrency for profit. Further, computer users within an organization such as a corporation may on occasion attempt to perform unauthorized network communications or perform other functions, such as running file sharing programs or mining cryptocurrency using the corporation's computing resources and power.

Malware such as this is often spread by sending users email with links to malware that purport to link to other content, or by creating web pages or content that appear to be benign but that execute or install malicious code on the user's computer. Malicious websites can also pretend to be or “spoof” legitimate websites, tricking users into entering usernames, passwords, credit card account numbers, or other sensitive information. For reasons such as these, it is desirable to manage user interaction with known or suspected malicious websites.

### SUMMARY

One example embodiment of the invention comprises a method of restricting presentation of known or suspected malicious content in a web browser using a restricted browsing mode. A request for web content is received in the browser, and the browser's restricted browsing mode software determines whether the web content contains known or suspected malicious content. If the requested web content contains known or suspected malicious web content, the requested web content is displayed in a restricted browsing mode that restricts or blocks presentation of one or more elements of the known or suspected malicious content in the requested content.

In a further example, blocking presentation comprises blocking one or more of downloads, links, password or account number requests, and scripts.

In another example, the known or suspected malicious content comprises content that poses a risk to the computer, such as viruses, malware, ransomware, and other such content, or content that poses a danger to the user, such as attempts to cause the user to divulge user names and passwords, bank account or credit card numbers, or personally identifiable information (PII) such as birthdate and social security number. In a further example, the restricted or blocked content includes content that may be considered objectionable or age-inappropriate, such as content related to smoking/vaping, alcohol or drugs, and content related to violence, weapons, or portrayal of harmful or dangerous activities.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a computer network environment including a client computer system having a web browser with a restricted browsing mode, consistent with an example embodiment.

FIG. 2 is a screen image of a typical web browser warning that a page may contain malicious content.

FIG. 3 is a screen image of a web browser warning that a page may contain malicious content with an option to view the web page in an extra safe browsing mode, consistent with an example embodiment.

FIG. 4 is a diagram showing how a client computer system executing a restricted browsing mode module in a web browser interacts with a threat management server, consistent with an example embodiment.

FIG. 5 is a flowchart of a method of providing a restricted browsing mode in a web browser, consistent with an example embodiment.

FIG. 6 is a computerized computer system comprising a browser with a restricted browsing mode module operable to restrict presentation of network traffic that is known or suspected to be malicious, consistent with an example embodiment.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices become more ingrained into our daily lives, the value of the information they store, the data such as passwords and financial accounts they capture, and even their computing power becomes a tempting target for criminals. Hackers regularly attempt to log in to a corporate computer to steal, delete, or change information, or to encrypt the information and hold it for ransom via “ransomware.” Malware containing cryptocurrency mining software uses computing resources and power from other people's computers to mine for cryptocurrency. Smartphone apps, Microsoft Word documents containing macros, Java applets, and other such common documents are all frequently infected with malware of various types, and users rely on tools such as antivirus software, firewalls, or other malware protection tools to protect their computerized devices from harm.

In a typical home computer or corporate environment, desktop computers, laptops, smartphones, tablet computers, and other such devices commonly use web browsers to access content from the World Wide Web, a part of the Internet. The web pages that make up the World Wide Web provide a wide variety of information and services to users, from online shopping, banking, and medical account management tools to social media, news sources, and games. But not all websites are legitimate or have helpful intentions, and some are used to distribute illegal software or media, to spread malware such as viruses, or to capture personal user information such as passwords or financial account numbers.

Some web browsers have tools to manage such threats, such as antivirus or antimalware software that is operable to inspect web pages and other online content, and to flag known or suspected malicious content. Web browsers may also have features that block certain known malicious web pages from loading, such as using a blacklist of web pages or other online content that have been found to contain malicious elements in the past. But, antivirus software doesn't recognize many new threats or some threats that evolve over time, and blacklisting a page and blocking it prevents the user from being able to access content that may be of value to the user. There is therefore a need for an online content risk management solution that protects an end user from malicious content, while permitting the user to view content that may be of value or interest such as content on web pages that have been blacklisted.

Some example embodiments presented herein therefore comprise web browsers and other networked content management software that provides an “extra-safe” mode for accessing content on known or suspected malicious web pages, such as by restricting the user's ability to download content or enter sensitive information such as usernames, passwords, and account numbers, and restricting web pages' ability to execute scripts.

In further embodiments, other features or actions on web pages or other content are restricted to protect the user, but the core content of the web page or other such content is still presented to the user. This substantially reduces the risk in allowing a user to view a known or suspected malicious web page by blocking the most dangerous or risky behaviors or functions on the web page, but does not block or prevent the user from viewing the web page entirely. In another example, the user can perform one or more of the restricted or blocked functions such as downloading content or entering a password after performing a further action such as accepting a disclaimer and/or entering an authorization password or PIN for the extra-safe browsing tool.

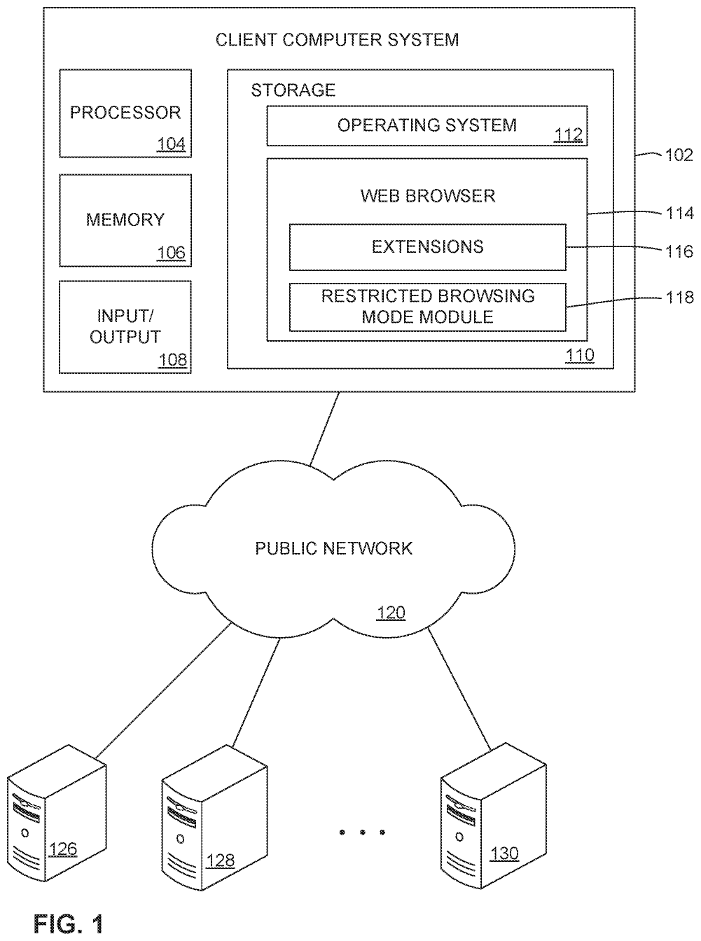

FIG. 1 shows a computer network environment including a client computer system having a web browser with a restricted browsing mode, consistent with an example embodiment. Here, a client computer system 102 includes a processor 104 operable to execute computer instructions, a memory 106 operable to store computer instructions for execution and other computer data while the computer is running, and input/output 108 operable to exchange data with other devices such as peripherals and other computer systems. Storage 110 stores data that is retained when the power is turned off, such as an installed operating system 112 and software such as web browser 114.

The web browser in this example includes software modules that add additional functionality such as plug-ins or extensions 116, including restricted browsing mode module 118. Although the restricted browsing mode module 118 is shown as an extension in this example, in other examples it is integrated into the web browser, is integrated into other software such as an antivirus or anti-malware software package, or is provided via another mechanism.

In the example of FIG. 1, the client computer system 102 is coupled to a public network 120 such as the Internet, which enables the client computer system to communicate with remote computers such as 126-128. The computer system in this example is also operable to communicate with a remote service provider 130 that provides in various embodiments up-to-date information such as a website blacklist, malware or and virus signatures, and other such information to the restricted browsing module 118.

In operation, the client computer system allows a user to execute programs such as web browser 114 via its operating system 112. The web browser in this example includes various extensions including a restricted browsing module 118 that serves to restrict presentation of or access to at least some known or suspected web content, providing the user with a safer web browsing environment. In a traditional system with no restricted browsing mode module, a user attempting to load a page that is known or suspected to be malicious may be blocked by the browser or by anti-malware or antivirus software, typically recommending the user not visit the suspect web page but also giving the user the option of ignoring the warning and visiting the web page with a warning regarding the possible risks. In the example of FIG. 1, when a user attempts to load a page that has known or suspected malicious content, the restricted browsing module presents the web page with some content altered to protect the user from malicious content.

In a more detailed example, the restricted browsing module displays the requested web page but does not display or restricts the functionality of content that can pose a risk such as a request for login credentials, requests for financial account numbers or related information, scripts or other executable code, and download links. The restricted browsing mode in a further example blocks content that may pose a danger to a computer system such as malware, viruses, Trojans, and ransomware. In another example, the restricted browsing mode blocks content that may put a user at risk, such as personally identifiable information, account numbers, and user names or passwords. In a further example, the restricted browsing mode restricts content that is undesirable, such as pornography or sexually explicit content or content using vulgar language, content related to smoking/vaping, alcohol, or drugs, and content related to violence, weapons, or portrayal of harmful or dangerous activities.

The restricted browsing module identifies web pages and content that may be risky in some examples by comparing a request for content received in a web browser, such as a URL, with a blacklist of known or suspected malicious web content. In a more detailed example, an up-to-date blacklist is provided by remote service provider 130. In another example, the web content is evaluated based on technology such as signatures, heuristics, artificial intelligence, or other such methods to determine whether content on a web page may be risky and should be restricted.

A user or administrator of the client computer system 102 running the web browser 114 that includes a restricted browsing mode module can in some examples configure the restricted browsing mode module to restrict some content but not restrict other content, such as to block content that may include malware or viruses but not to block content that may be objectionable or only appropriate for certain ages. In another example, the restricted browsing mode module can be configured to show or provide access to content that has been restricted such as by entering a password or personal identification number (PIN), or by clicking acceptance of a warning identifying the content as potentially risky. In a further example, different users will have different permissions or abilities to block or unblock content using methods such as those described here.

The restricted browsing mode module 118 is implemented in the example of FIG. 1 as an plugin for a web browser, but in other examples will be implemented as part of the browser software, as a networked computer service, as part of an antivirus or anti-malware software suite or package, or through other suitable means. The software that performs the determination of whether a website or other web content is known or likely malicious is in some examples different software or is software executing on a different computer than software that performs restriction or blocking of content, such as where an external antivirus software or cloud service are used to determine the risks associated with various networked content. Each of the configurations and examples here can be configured to perform a similar function of restricting presentation of or access to certain networked content that has been determined to pose a risk, while displaying other content that is static or has been otherwise determined unlikely to pose a risk.

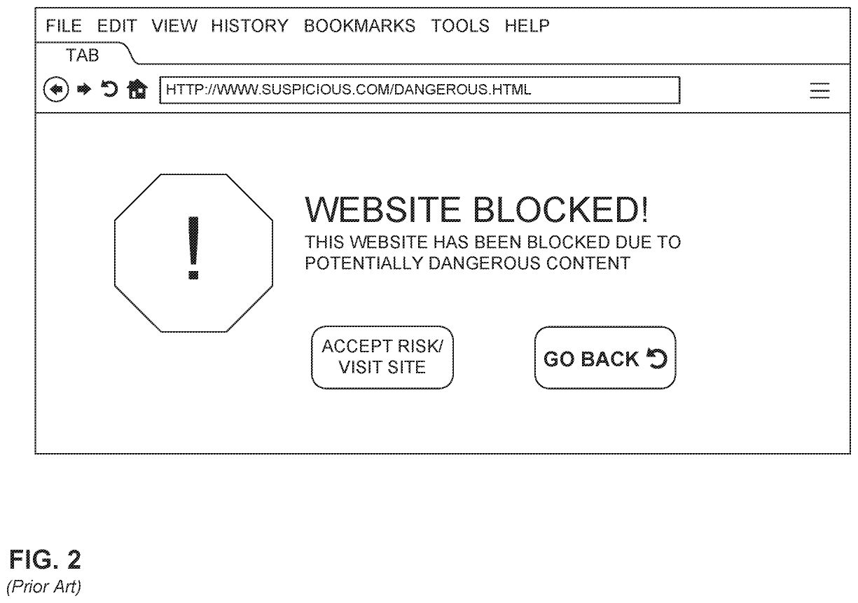

FIG. 2 is a screen image of a typical web browser warning that a page may contain malicious content. Here, a user has navigated to or entered the URL of a potentially malicious web page, which the browser has recognized as being potentially malicious such as by finding the URL, IP address, or other such reference to the web page on a blacklist. The web browser has therefore not presented the requested web page, but has instead presented a warning page indicating that the web page has been blocked. The warning page further encourages the user to go back to the last page visited, while giving the user the additional option of accepting any potential risks in visiting the blocked web page and visiting the page despite the warnings.

Going back protects the user from the potentially malicious content on the blocked web page, but also prevents the user from viewing whatever web page content caused the user to navigate to the web page. The user therefore has the undesirable choice of either not viewing the desired content and remaining safe, or visiting the site despite the warnings to view the desired content but risking malware or other dangers on a web page already determined to be particularly risky.

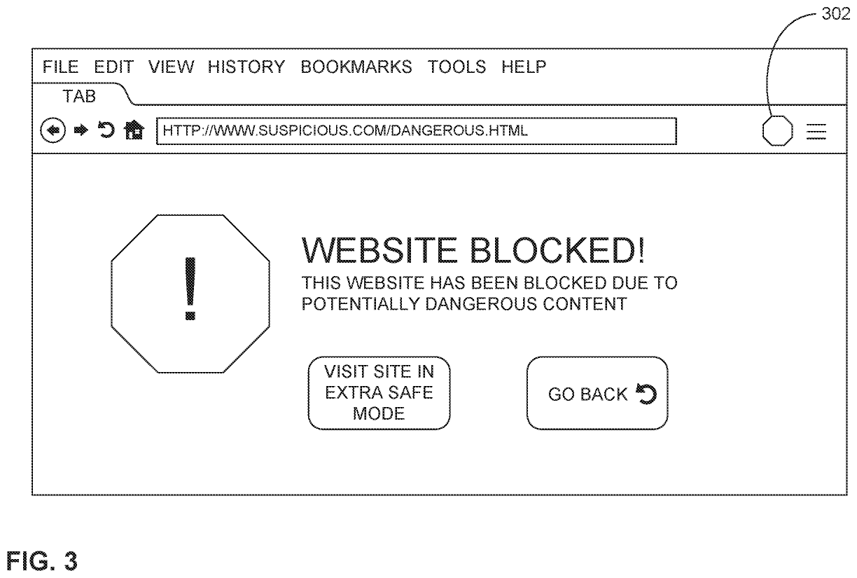

FIG. 3 is a screen image of a web browser warning that a page may contain malicious content with an option to view the web page in an extra safe browsing mode, consistent with an example embodiment. Here, an extension providing an extra-safe or restricted browsing mode has been installed, as evidenced by the extension logo at 302. As in the example of FIG. 2, a user has navigated to or entered the URL of a potentially malicious web page. The restricted browsing mode extension has recognized that the web page may contain potentially malicious data, such as by using a blacklist of known or suspected malicious web pages, antivirus or anti-malware software, heuristics configured to recognize characteristics of malicious content, artificial intelligence, or other such systems.

Based on this determination of the web page potentially containing malicious content, the web page has been blocked, much as with the example of FIG. 2. However, the user here has the option of going back or visiting the webpage in an extra-safe or restricted browsing mode, which selectively blocks certain content or functionality that is the most likely to pose a risk to the user or the user's computer system. In an alternate embodiment, no screen showing that the web page has been blocked is presented, but the user is automatically shown a restricted version of the web page with the content known or suspected to be malicious blocked. In another embodiment, the user is presented a brief warning before the page loads or after the page has loaded that the page is being viewed in extra-safe or restricted browsing mode due to potentially malicious content.

The content that is restricted or blocked by the restricted browsing mode extension in this example includes content that poses a risk to the computer, such as viruses, malware, ransomware, and other such content that can cause damage to the computer such as by altering its software or operating system. The restricted or blocked content also includes content that poses a danger to the user, such as attempts to cause the user to divulge user names and passwords, bank account or credit card numbers, or personally identifiable information (PII) such as birthdate and social security number. In a further example, the restricted or blocked content includes content that may be considered objectionable or age-inappropriate, such as content related to smoking/vaping, alcohol or drugs, and content related to violence, weapons, or portrayal of harmful or dangerous activities.

The restrictions on content may be desirably overridden in some instances, such as where the user has a user name and password unique to the site being visited and understands the risks associated with providing them to the website. In such cases, the user may elect to bypass the restrictions or blocking of certain content, such as by entering a password or personal identification number allowing the user to bypass the restricted browsing mode limitations.

Restricting presentation or function of various web page content that is known or suspected to be malicious enables the user to still view the web page and likely find the content for which they were searching, while still protecting the user from the content that is known or believed to be malicious. A restricted browsing mode is therefore an improvement over the prior art, which simply blocked a user from viewing a potentially suspect web page, or exposed the entire page along with any potentially risky content to the user.

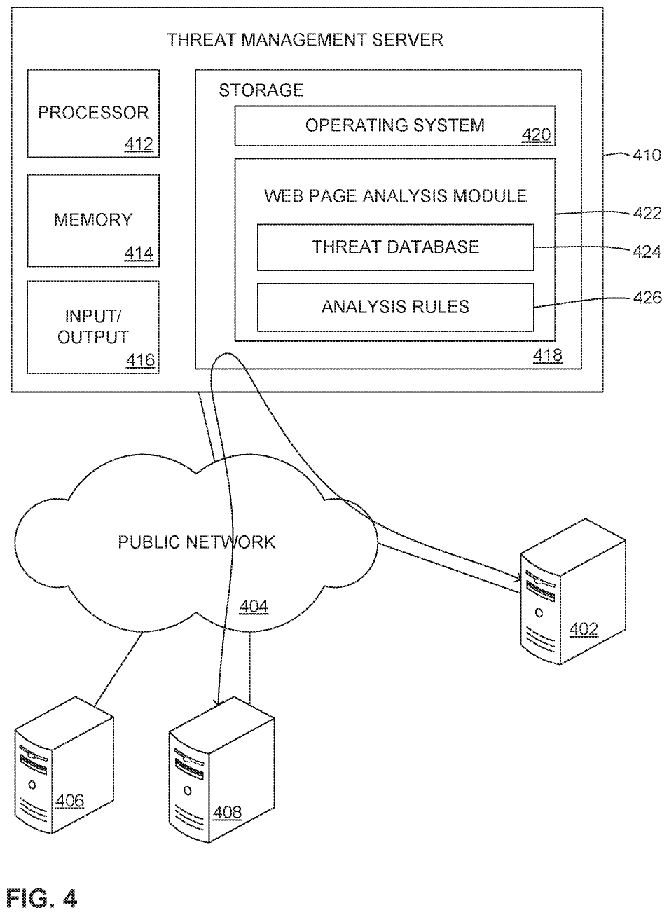

FIG. 4 is a diagram showing how a client computer system executing a restricted browsing mode module in a web browser interacts with a threat management server, consistent with an example embodiment. Here, the client computer system 402 is a computer used by an end user to access content on a public network 404, such as web servers 406 and 408 on the Internet. The client computer 402 is executing a restricted browsing mode module integrated with the web browser, as in the examples of FIGS. 1 and 3. When a request for a web page is entered, the restricted browsing mode module sends notice of the web page request to a threat management server 410, which is operable via its web page analysis module 422 to use a threat database 424 to search for known risky websites or web pages, and analysis rules 426 to determine whether any characteristics such as malware signatures, heuristics, or artificial intelligence analysis conclude that content on the requested web page may be malicious. The threat management server 410 then notifies the client computer system 402's restricted browsing mode module of the status of the web page being requested, and in a further example of the risks associated with various content on the requested web page.

In another example, when a web page is determined to potentially have malicious content, the web page is not directly loaded but is first analyzed by the threat management server 410 which then provides an “extra safe” version of the web page with content determined to be suspicious to the client computer 402. This ensures that the client computer uses up-to-date analysis rules and threat data on the threat management server in determining whether content is malicious, while also providing the threat management server with immediate notice of any potentially malicious content on the server for recordation in its database.

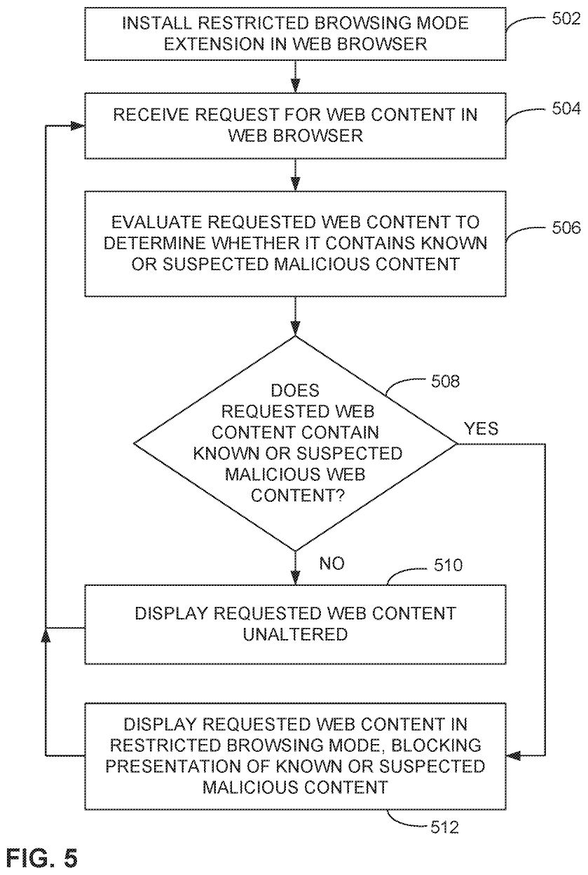

FIG. 5 is a flowchart of a method of providing a restricted browsing mode in a web browser, consistent with an example embodiment. At 502, a client computer user or administrator installs a restricted browsing mode module, such as by installing an extension in a web browser or installing a browser with restricted browsing mode functionality built in. The user requests web content at 504, such as by clicking on a link to a web page or by entering a URL in an address bar of the web browser.

The requested web content is evaluated at 506 to determine whether it contains known or suspected malicious content, such as by using antivirus or anti-malware software to scan the content or by using a blacklist of known or suspected malicious web pages. At 508, if the requested web page does not contain known or suspected malicious web content, the process proceeds to 510 and the web content is displayed unaltered in the web browser's regular browsing mode. If the requested web content contains known or suspected malicious web content at 508, the process proceeds to 512 where the requested web content is displayed in a restricted browsing mode that blocks presentation of known or suspected malicious content.

The known or suspected malicious content in some examples comprises content that poses a risk to the computer, such as viruses, malware, ransomware, and other such content, as well as content that poses a danger to the user, such as attempts to cause the user to divulge user names and passwords, bank account or credit card numbers, or personally identifiable information (PII) such as birthdate and social security number. In a further example, the restricted or blocked content includes content that may be considered objectionable or age-inappropriate, such as content related to smoking/vaping, alcohol or drugs, and content related to violence, weapons, or portrayal of harmful or dangerous activities.

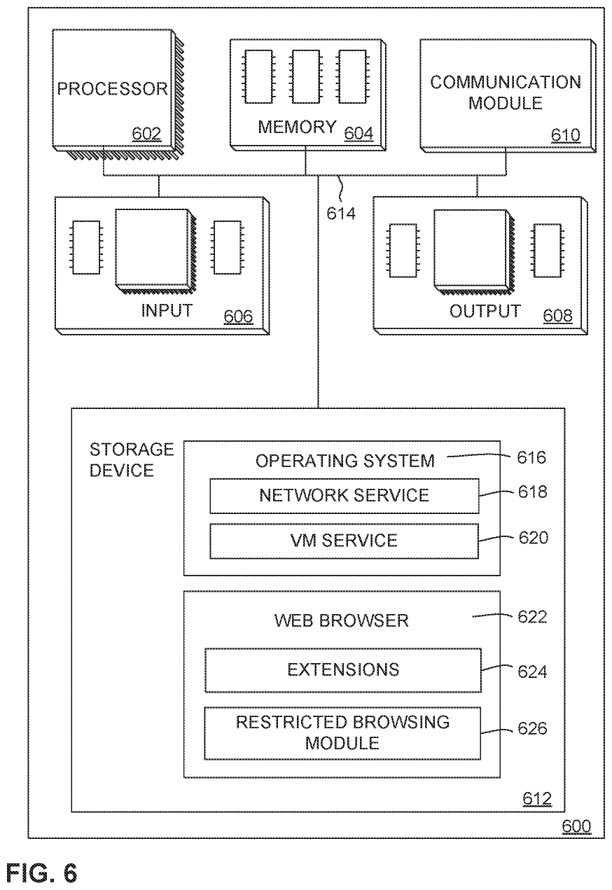

The examples described herein illustrate how a web browser incorporating a restricted browsing mode can provide a user with relatively safe access to suspicious or potentially dangerous web content that would otherwise be blocked or subject the user to greater potential dangers. Similar methods can be used for other network content, such as online content accessed via an app on a smartphone or other such network content retrieval. Although some computerized devices such as a client computer, server, and others have been illustrated in the examples above, these devices in other embodiments may take other forms or have other features, such as those described in conjunction with the example computer of FIG. 6.

FIG. 6 is a computerized computer system comprising a browser with a restricted browsing mode module operable to restrict presentation of network traffic that is known or suspected to be malicious, consistent with an example embodiment. FIG. 6 illustrates only one particular example of computing device 600, and other computing devices 600 may be used in other embodiments. Although computing device 600 is shown as a standalone computing device, computing device 600 may be any component or system that includes one or more processors or another suitable computing environment for executing software instructions in other examples, and need not include all of the elements shown here.

As shown in the specific example of FIG. 6, computing device 600 includes one or more processors 602, memory 604, one or more input devices 606, one or more output devices 608, one or more communication modules 610, and one or more storage devices 612. Computing device 600, in one example, further includes an operating system 616 executable by computing device 600. The operating system includes in various examples services such as a network service 618 and a virtual machine service 620 such as a virtual server. One or more applications, such as web browser 622 are also stored on storage device 612, and are executable by computing device 600.

Each of components 602, 604, 606, 608, 610, and 612 may be interconnected (physically, communicatively, and/or operatively) for inter-component communications, such as via one or more communications channels 614. In some examples, communication channels 614 include a system bus, network connection, inter-processor communication network, or any other channel for communicating data. Applications such as web browser 622 and operating system 616 may also communicate information with one another as well as with other components in computing device 600.

Processors 602, in one example, are configured to implement functionality and/or process instructions for execution within computing device 600. For example, processors 602 may be capable of processing instructions stored in storage device 612 or memory 604. Examples of processors 602 include any one or more of a microprocessor, a controller, a digital signal processor (DSP), an application specific integrated circuit (ASIC), a field-programmable gate array (FPGA), or similar discrete or integrated logic circuitry.

One or more storage devices 612 may be configured to store information within computing device 600 during operation. Storage device 612, in some examples, is known as a computer-readable storage medium. In some examples, storage device 612 comprises temporary memory, meaning that a primary purpose of storage device 612 is not long-term storage. Storage device 612 in some examples is a volatile memory, meaning that storage device 612 does not maintain stored contents when computing device 600 is turned off. In other examples, data is loaded from storage device 612 into memory 604 during operation. Examples of volatile memories include random access memories (RAM), dynamic random access memories (DRAM), static random access memories (SRAM), and other forms of volatile memories known in the art. In some examples, storage device 612 is used to store program instructions for execution by processors 602. Storage device 612 and memory 604, in various examples, are used by software or applications running on computing device 600 such as web browser 622 to temporarily store information during program execution.

Storage device 612, in some examples, includes one or more computer-readable storage media that may be configured to store larger amounts of information than volatile memory. Storage device 612 may further be configured for long-term storage of information. In some examples, storage devices 612 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 600, in some examples, also includes one or more communication modules 610. Computing device 600 in one example uses communication module 610 to communicate with external devices via one or more networks, such as one or more wireless networks. Communication module 610 may be a network interface card, such as an Ethernet card, an optical transceiver, a radio frequency transceiver, or any other type of device that can send and/or receive information. Other examples of such network interfaces include Bluetooth, 4G, LTE, WiFi, Near-Field Communications (NFC), and Universal Serial Bus (USB). In some examples, computing device 600 uses communication module 610 to wirelessly communicate with an external device such as via public network 120 of FIG. 1.

Computing device 600 also includes in one example one or more input devices 606. Input device 606, in some examples, is configured to receive input from a user through tactile, audio, or video input. Examples of input device 606 include a touchscreen display, a mouse, a keyboard, a voice responsive system, video camera, microphone or any other type of device for detecting input from a user.

One or more output devices 608 may also be included in computing device 600. Output device 608, in some examples, is configured to provide output to a user using tactile, audio, or video stimuli. Output device 608, in one example, includes a display, a sound card, a video graphics adapter card, or any other type of device for converting a signal into an appropriate form understandable to humans or machines. Additional examples of output device 608 include a speaker, a light-emitting diode (LED) display, a liquid crystal display (LCD), or any other type of device that can generate output to a user.

Computing device 600 may include operating system 616. Operating system 616, in some examples, controls the operation of components of computing device 600, and provides an interface from various applications such as router module 622 to components of computing device 600. For example, operating system 616, in one example, facilitates the communication of various applications such as router module 622 with processors 602, communication unit 610, storage device 612, input device 606, and output device 608. Applications such as web browser 622 may include additional program instructions and/or data that are executable by computing device 600. As one example, web browser 622 includes extensions 624 operable to provide additional functionality to the web browser, such as restricted browsing module 626 operable restrict presentation of known or suspected malicious content. These and other program instructions or modules may include instructions that cause computing device 600 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of improving safety in a web browsing environment, comprising:
receiving a request for web content;
determining that the requested web content is known or suspected to include malicious content; and
changing a mode of a web browser to restrict presentation of the known or suspected malicious content in the requested content.

2. The method of improving safety in a web browsing environment of claim 1, wherein restricting presentation of known or suspected malicious content comprises one or more of restricting a request for login credentials, financial account numbers or related information, scripts, executable code, and download links.

3. The method of improving safety in a web browsing environment of claim 1, wherein the determining is performed by comparing the received request for web content against a blacklist of known or suspected malicious web content.

4. The method of improving safety in a web browsing environment of claim 1, wherein the determining is performed by evaluating the content in the received request for web content using one or more of signatures, heuristics, or artificial intelligence.

5. The method of improving safety in a web browsing environment of claim 1, wherein changing a mode of the browser further comprises allowing presentation of the known or suspected malicious content in the requested content upon one or more of acknowledgment of a warning or receipt of a password or personal identification number (PIN).

6. The method of improving safety in a web browsing environment of claim 1, wherein the method is implemented in a web browser.

7. The method of improving safety in a web browsing environment of claim 1, wherein the method is implemented in a web browser extension or plugin.

8. The method of improving safety in a web browsing environment of claim 1, wherein the determining is performed using a networked computer service in communication with the web browser.

9. The method of improving safety in a web browsing environment of claim 1, wherein the determining is performed using anti-malware software installed on the same computer as the web browser.

10. The method of improving safety in a web browsing environment of claim 1, wherein malicious content comprises content that may pose a danger to a computer system such as malware, viruses, Trojans, and ransomware.

11. The method of improving safety in a web browsing environment of claim 1, wherein malicious content comprises content that may put a user at risk, such as personally identifiable information, account numbers, and user names or passwords.

12. The method of improving safety in a web browsing environment of claim 1, wherein malicious content comprises content that is undesirable such as pornography or sexually explicit content or content using vulgar language, content related to smoking/vaping, alcohol, or drugs, and content related to violence, weapons, or portrayal of harmful or dangerous activities.

13. A method of improving safety in a networked environment, comprising:
receiving a request for content from a network server;
determining that the requested content is known or suspected to include malicious content; and
changing a mode of a network client to restrict network client access to the known or suspected malicious content in the requested content.

14. The method of improving safety in a networked environment of claim 13, wherein restricting presentation of known or suspected malicious content comprises one or more of restricting a request for login credentials, financial account numbers or related information, scripts, executable code, and download links.

15. The method of improving safety in a networked environment of claim 13, wherein the determining is performed by comparing the received request for web content against a blacklist of known or suspected malicious web content, or by evaluating the content in the received request for web content using one or more of signatures, heuristics, or artificial intelligence.

16. The method of improving safety in a networked environment of claim 13, wherein changing a mode of the network client further comprises allowing presentation of the known or suspected malicious content in the requested content upon one or more of acknowledgment of a warning or receipt of a password or personal identification number (PIN).

17. The method of improving safety in a networked environment of claim 13, wherein the determining is performed using a networked computer service in communication with the network client.

18. The method of improving safety in a networked environment of claim 13, wherein the determining is performed using anti-malware software installed on the same computer as the network client.

19. The method of improving safety in a networked environment of claim 1, wherein malicious content comprises content that may pose a danger to a computer system such as malware, viruses, Trojans, and ransomware.

20. The method of improving safety in a networked environment of claim 1, wherein malicious content comprises content that may put a user at risk, such as personally identifiable information, account numbers, and user names or passwords.
